(19) United States
(12) Patent Application Publication
(10) Pub. No.: US 2003/0065594 A1
(43) Pub. Date: Apr. 3, 2003

(54) Multilateral allocated-credit foreign exchange risk hedging method and system

(75) Inventor: Brendan Murphy, Middletown, CT (US)

Correspondence Address: LAW OFFICES OF JOSEPH F. MURPHY, 101 WEST 23RD STREET, #2367, NEW YORK, NY, 10011-2490, US

(73) Assignee: FXotica.com, INC.

(21) Appl. No.: 09/967,482

(22) Filed: Sep. 28, 2001

(51) Int. Cl. G06F 17/60

(52) U.S. Cl. 705/35; 705/26

(57) ABSTRACT

A method and system for conducting foreign exchange transactions, whereby the company-user derives benefits comprising greater ease in conducting foreign exchange transactions, greater choice in transactional counterparties with as a consequence more competitive transaction pricing, and whereby participating financial institutions derive benefits comprising establishing contact with new counterparties and potential clients, accommodating the desire of existing clients for a more supple and cost-efficient foreign exchange transacting system, providing competitive foreign exchange services to their small enterprise customers where the provision of such services is not one of the institution's core competencies or where provision of such services to small businesses is not cost-effective.

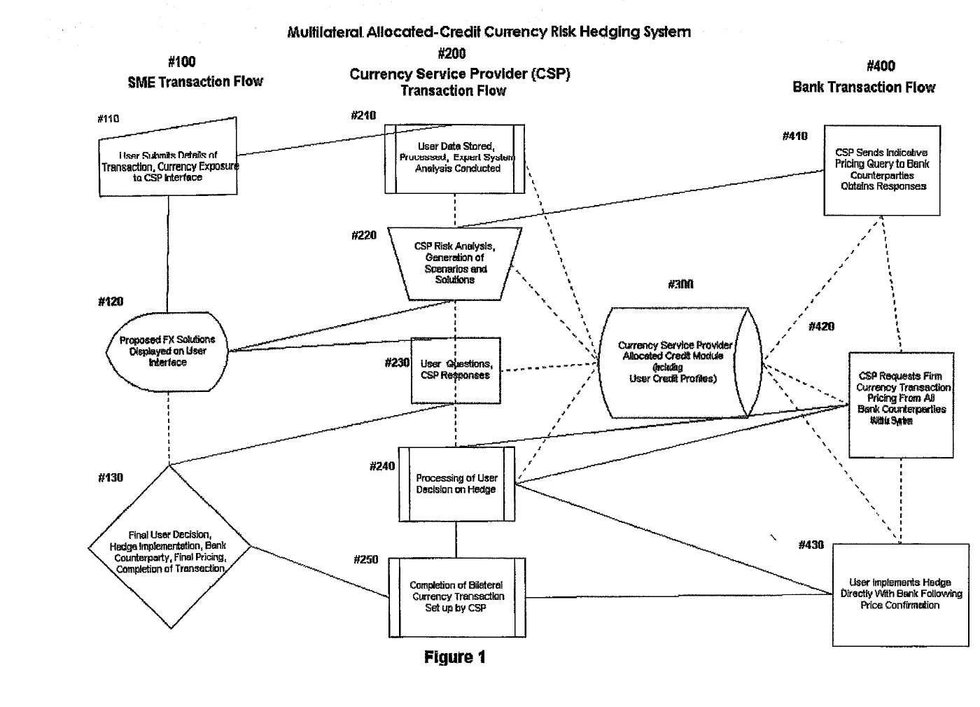

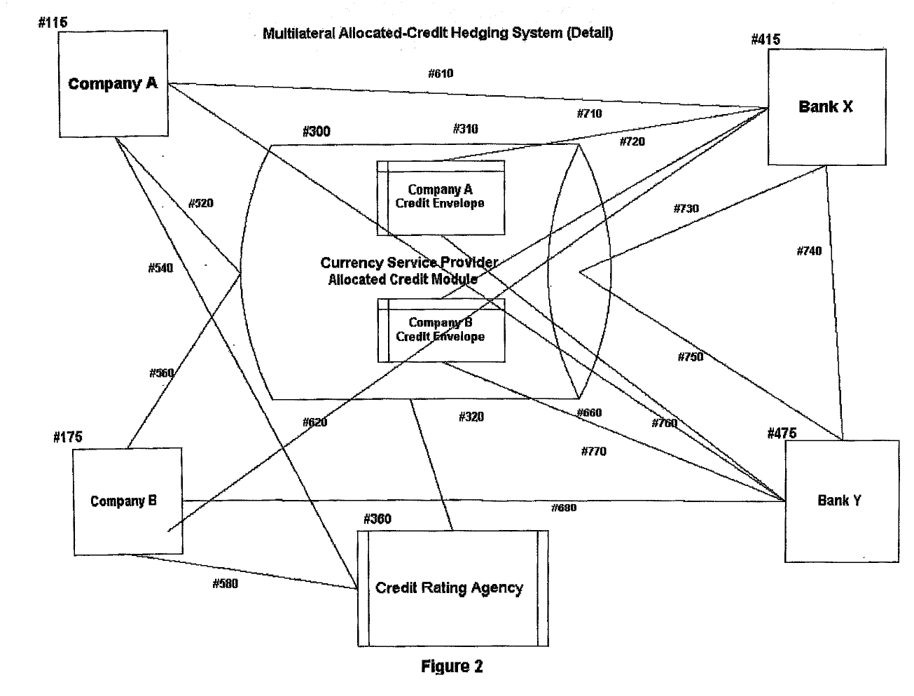

### STATEMENT OF PROBLEM AND BACKGROUND OF THE INVENTION

Corporations engaged in international trade must consider the risk of currency values rising or falling in the period between a transaction and its settlement. This is true whether the company is an exporter (in which case it is concerned with the value of the currency in which it is being paid) or an importer (in which case it is concerned with the value of the currency in which it must pay.) Thus, there is always present the concern that the value of the “transaction currency” might significantly rise or fall in the period between agreement of the transaction and its settlement.

Measures known as “foreign exchange risk hedging” may be taken using currency agreements or other financial market instruments to protect against the adverse consequences of foreign exchange volatility. However, companies engaging in such agreements or contracts must have a credit standing in the financial markets to provide assurance to their counterparties in such arrangements that they will, upon the term of such agreements, be capable of meeting all obligations. The need for such a generally recognized credit standing, and the practical realities of how it is obtained, have a significant bearing upon the feasibility of undertaking such currency hedging operations.

For the large multinational corporation (MNC) with international treasury managers, dealing with foreign exchange risk is a relatively straightforward matter, even though the actual work of dealing with foreign exchange risk, including the execution of currency hedges, is at times in itself a complex task. One the one hand, large MNCs tend to have obtained ratings from one or more of the major international credit agencies, such as Moody's Investors Services or Standard & Poor's, while on the other hand large international corporations also tend to have relationships with a number of banks that want their business and will quote them competitive foreign exchange rates.

Dealing with foreign exchange risk is far more problematic for small and medium-sized enterprises (SMEs) which not only lack such credit ratings but do not have international treasury managers on staff. The typical SME may find it difficult to obtain credit from a bank other than one with which it already has an existing relationship, and it could be difficult at best for them to use the credit line they have obtained from one bank to engage in currency hedging at another bank. Therefore, a small business typically must delegate this currency hedging function to one of the banks with which it has a relationship, and as a result will generally pay a substantial premium for such services, either as an outright fee for service, or through currency exchange rates substantially higher than those in the open market.

Heretofore, smaller enterprises have not had extensive choice as to the bank they will use for currency hedging. This is because (as will be explained below) currency risk hedging necessarily involves the provision of credit to the smaller enterprise doing the hedging and as the smaller enterprise can most easily obtain the requisite credit from the bank it already has a credit relationship with, it must do its currency hedging with that same bank, regardless of how unfavorable are the prices that bank exacts for hedging operations.

Smaller enterprises which might wish to obtain such currency hedging services at more competitive rates can be hindered in pursuing this objective by the prevailing methods of the prior art, which frequently establishes a nexus between the currency hedging process and a company's banking relationships. The most common way to hedge currency risk is to enter into a “forward currency agreement” which is an agreement to exchange the transaction currency for the company's home or accounting currency at some future date. The forward currency agreement has the effect of fixing, at a future point in time, the exchange rate for that transaction amount between the transaction currency and the company's home or accounting currency. For example, a U.S. company that is to receive Mexican pesos in payment of an export sale when the transaction is concluded in three months would enter into a forward currency agreement under which it would sell that amount of Mexican pesos forward three months, receiving a predetermined number of U.S. dollars at that future date. The forward exchange rate set between the Mexican pesos and U.S. dollar is primarily determined by the interest rate differential for three-month funds between the U.S. and Korea, though other factors may impinge.

Credit arises as a factor in this operation because the counterpart, in this case the bank with which the small business contracts to exchange Mexican pesos for U.S. dollars three months hence, needs an assurance that at that term, the small business will be able and willing to deliver Mexican pesos for U.S. dollars in the agreed amount. If the exchange rate was unchanged over that term, failure by the firm to make good on its promise would have limited consequences for the bank counterparty—though the default would have serious implications for the firm's general credit standing. However, were the exchange rate to move significantly over the intervening period, the bank counterparty might have sustained a loss equal to the change in value of the Mexican pesos it had agreed to accept, or in the case of an appreciating Mexican pesos, missed an opportunity for profit (the consequences for the counterparty bank would depend on whether it had maintained that currency exposure or hedged it away itself; in either case the firm's default would be most seriously deplored).

Thus the need for a credit rating or more likely a guarantee from an established institution, without which most banks might not enter into such an agreement with a small business of uncertain resources and reliability. Unlike large multinational corporations, most smaller companies do not have a rating from one of the global agencies, let alone the capacity to conduct such transactions without a bank intermediary (more sophisticated MNC treasury departments are able to obtain direct access to the foreign exchange market through the Reuters dealing system, for instance). Therefore, the foreign exchange hedging function is closely tied to the credit relationship between a small business and its principal bankers, and so a special “nexus” develops between the small business and its principal bankers This nexus is often reinforced by the need of the small business to obtain or negotiate a letter of credit guaranteeing payment for the trade goods, or by an implicit link between bank credit and use of a bank's currency services.

While such close credit relationships are necessary and beneficial to small businesses, they present an obstacle to increased efficiency of cost and time in currency hedging operations. If a small business is in effect captive to one bank or a small number of banks in obtaining currency hedging services, it cannot benefit to the fullest extent from competitive forces in the broader currency marketplace to reduce its currency hedging costs. Before the advent of pervasive access to a Global Computer Network (commonly called the “Internet”), there were fewer alternatives for small businesses. But the emergence of multi-bank, auction-based currency dealing sites presents a more cost-efficient alternative for addressing foreign exchange risk.

Thus, it is in the interest of small businesses engaged in international trade, and also in the interest of the international system of trade, to elaborate a method and system by which small businesses that must protect themselves against the adverse consequences of exchange rate volatility may do so at the lowest possible cost and in a more expeditious manner. This requires a more supple link between the bank credit function and foreign exchange operations, so as to permit SMEs to choose more freely among foreign exchange trading institutions, or indeed the elaboration of a means by which currency operations may be effected independently of credit relationships.

### SUMMARY OF INVENTION

The business method described herein proposes to integrate the general credit profile of a small or medium-sized enterprise and an allocated portion of the bank credit line or lines which have been obtained by a small or medium-sized business, into the open-market process by which such a company may seek competitive pricing of transactions required to implement a foreign exchange hedge. The process may be referred to as an “allocated-credit, multilateral foreign exchange risk hedging process.”

The specialized financial services company whose role is to facilitate this currency hedging process not only stands as an intermediary between the enterprise and the foreign exchange dealing systems which offer competitive currency rates, but establishes and maintains, with the assistance of recognized international and single-country credit agencies, a corporate credit profile which permits potential bank counterparties of the enterprise to appraise its financial stability and credit history. The bank (or banks) with which the enterprise has its primary credit relationship(s) allocates some portion of such unilateral credit line(s) to a multilateral credit facility maintained in conjunction with the corporate credit profile, in effect creating an “envelope” of credit on which the enterprise may draw to enable currency transactions with banks other than its primary bank within this allocated-credit, multilateral hedging system.

### BRIEF DESCRIPTION OF THE DRAWING

FIG. ONE is a schematic drawing illustrating a Multilateral Allocated Credit Currency Risk Hedging System according to the present invention.

FIG. TWO is depicts further detail of the system of FIG. ONE

### DETAILED DESCRIPTION

The currency hedging service company envisioned here, hereinafter referred to as the Currency Service Provider 200, will establish a relationship with one or more businesses engaged in trade, hereinafter referred to as the Business (illustrated for exemplary purposes as Business A 115 and Business B 115). The relationship which each Business has with the Currency Service Provider is separate and distinct from the relationship(s) which each Business may maintain with a primary banking institution or institutions, e.g. Bank X 415 and/or Bank Y 475 or another credit institution or financial services provider (not illustrated for brevity). Each business enters into an agreement with the Currency Service Provider under which each business states that it seeks the advice and assistance of the Currency Service Provider 200 to mitigate currency risk arising from its international trade activities, and asks the Currency Service Provider to serve as an intermediary with banks (e.g. Bank X 415 or Bank Z 475 that can provide currency transactional services essential to the enterprise's institution of adequate currency risk hedges.

According to the presently disclosed method, once this relationship has been established between the Currency Service Provider 200 and a business, a number of procedures may be engaged in to identify the currency risk that may arise from an international commercial transaction, to identify financial operations and strategies which will allow the business to eliminate or significantly mitigate that risk, and financial institutions able to carry out such operations and implement such strategies at a competitive rate. Typically this process will focus on one commercial transaction at a time. However, the Currency Service Provider 200 will, for each Business, maintain as a foreign exchange risk portfolio an ongoing record of outstanding transactions and will monitor that portfolio of currency hedges to identify collateral risks which may arise from the aggregate of such hedging arrangements, or to secure profits which may arise as an ancillary effect of the hedge.

As a first step, the Business presents the Currency Service Provider with the details (110) of the commercial transaction into which the Business has entered or which is envisioned by the Business. Such details would typically include, but would not be limited to, the transaction amount, the goods or services being sold or purchased, the invoice and/or bill of lading reference numbers, the identity of the commercial counterparty, the country of destination in the case of an export sale, or origin in the case of an import, the term of the transaction, the financing arrangements for the transaction (for instance, letter of credit or open account), details as to financial institutions already involved in the transaction, and most importantly the currency in which the transaction is agreed to be denominated.

The Currency Service Provider's expert software system(s) 210 will generate a number of basic parameters relevant to determining and addressing the foreign exchange risk that the transaction may present to the Business, such as market conditions, the historical volatility of the currencies involved in the transaction, the respective interest-rate structures attached to those two currencies, the interest rate differential between the interest rate structures of the currencies concerned over the term of the commercial transaction, the availability and cost of establishing a straightforward hedge using a forward currency agreement, and the availability and cost of other approaches such as options, swaps or other derivative instruments.

With input from the Currency Service Provider's professional treasury management staff, its foreign exchange rate analysts, data providers and forecasters, the system according to the present invention then generates the probable or potential scenarios for the currencies in question over the transaction term. Based on these scenarios, market conditions and other variables, the Currency Service Provider's computer system and expert staff generate proposed hedging solutions 220, and offer to the Business recommendations as to which solution is most appropriate from a cost-benefit standpoint or based on the Business's tolerance for risk as determined by information previously provided by the Business or through fresh queries to the Business's risk manager or managers. The Business's current credit profile is also examined and considered.

In these preliminary stages, the Currency Service Provider will generate estimates of the respective costs of various hedging solutions based on current market rates and prices, eventually requesting indicative prices for such transactions from bank counterparties 410 with which the Currency Service Provider has an established working relationship within the currency hedge model.

Once the Business has decided upon which hedging solution it wishes to implement (in further consultation with the Currency Service Provider or not, as the case may be 230), the Currency Service Provider 200 requests firm pricing from multiple bank counterparties (e.g. Bank X and Bank Y for the hedge or its component transactions. Once multiple firm prices have been obtained from the participating banks 420, the Business can decide 130 which bank it prefers to transact with, based on information provided in accordance with the present invention, including, but not limited to, the most competitive pricing and/or its preference for one of the participating banks based on existing relationships, previous transactions or general reputation.

Up to this point in the process the Currency Service Provider 200 has been the central participant in the process. However, once it has set up the desired electronic transaction between the Business and the counterparty bank the Business has chosen, it withdraws from the process 240 to enable the Business and counterparty bank to engage in a direct and bilateral transaction 250. The Currency Service Provider facilitates but does not broker the transaction, which takes place through an established and generally accepted computer-networked currency trading system, such as are well-known to those of ordinary skill in the art. The Business in effect conducts the transaction as would any other client of the counterparty bank, with the exception that the primary credit provider of the Business stands guarantor to the transaction amount. The transaction amount cannot exceed the credit available to the Business within the allocated-credit envelope instituted within the hedge model.

This kind of flexible and fluid currency hedging process would not be possible without the re-engineering, as described above, of the credit function as it typically bears on currency dealings by small to medium-sized corporations, or SMEs, as they are widely described. The small business typically has a limited number of institutions with which it can conduct foreign exchange transactions, because its credit standing is tied to a small number of banks, but the method or process described here provides smaller companies with more freedom and greater choice in conducting their foreign exchange transactions by the creation of the company credit module or database, which is maintained separately from a company's relationships with its principal or secondary banking partners, and the multilateral credit envelope which is established. This credit module permits small to medium-sized enterprises to assume ownership of their credit standing in much the same way that consumers in the United States and other countries with advanced financial systems establish and maintain credit ratings which are not tied to any single institution but which are in effect “portable” to other institutions.

A company's credit profile 300 within the Currency Service Provider's currency module is created at the request of the company, again referred to here as the Business. As in the case of a major corporation seeking a credit rating, the Business enters into an agreement with a Credit Rating Agency 360 selected by the Currency Service Provider to conduct a review of the financial condition of the Business, including its credit history. Once this has been completed and reviewed by the Business with the credit agency (providing the Business with an opportunity to correct erroneous information in the database or to contest the credit rating agency's conclusions) the Business authorizes the Credit Rating Agency and the Currency Service Provider to post the credit profile in the credit module where it can be accessed by all participating banks as necessary. When the Business seeks to engage in a currency transaction with a participating bank, the bank will have access to an up-to-date credit profile of the prospective client.

The availability of such a credit profile is necessary or at least desirable, but is not sufficient in itself to enable the Business to conduct foreign exchange transactions with institutions other than its primary or secondary lending institutions. One critical feature of the present business model is the allocation of credit by the Business's primary or secondary bank to the Currency Service Provider's credit module, thus enabling the Business to transact with banks other than the Business's primary banking institution for currency purposes.

For example, Company A 115, which has a primary banking relationship with Bank X 415, may have secured an overall credit line of $5 million from Bank X. Bank X, as a condition for its participation in the Currency Service Provider's business model, agrees to allocate $1 million of that overall line of credit to the Business A credit envelope 310 in the Service Provider's multilateral credit module, such that this allocated credit line may be called upon for transactions with banks other than Bank X for up to $1 million. Therefore, if Company A 115, after obtaining advice from the Currency Service Provider, wishes to engage in a $250,000 currency transaction with Bank Y 475, it can do so on the basis of the credit line allocated to the module by Bank X. In other words, Bank X 415 stands guarantor to Bank Y 475 for the $250,000 transaction. On completion of the transaction, Company A 115 would have a remaining credit envelope of $750,000 within the multilateral credit module on which it could draw for other such transactions. Once the transaction has been concluded to the satisfaction of the company and its bank counterparty (for instance at the term of a three-month forward contract), the envelope would be restored to $1 million.

While such an arrangement might not appear to be in the interest of Bank X 415 given its primary banking relationship with Company A 115 and its natural desire not to accommodate a competing bank, reciprocal arrangements by Bank Y 475 and others will enable Bank X to enter into foreign exchange transactions with customers of those banks in like manner. The benefit to all participating banks is that they can accommodate the natural desire of their customers to participate in both the established and generally accepted computer-networked currency trading system and the emerging, more open Internet currency trading environment to obtain best pricing for their foreign exchange transactions, while retaining the business of such customers for general banking services. This also permits banks with a competency in particular currencies to attract new customers for dealings in those currencies, and provides an opportunity to familiarize such customers with their other offerings. For example, Bank X 415 might retain its primary relationship with Company A 115 despite Company A's foreign exchange dealings with

What is claimed is:

1. A method for conducting foreign exchange transactions, said method comprising the steps of:
a) providing a host server computer or array of host server computers;
b) providing a user interface, database and processor with connections to banks as necessary for carrying out foreign exchange transactions;
c) providing a company credit information database on said host server computer or array of host server computers that contains information regarding the creditworthiness of companies adhering to the system, including the creditworthiness or credit profile of the user;
d) providing a database on said host server computer with information as to the credit line or envelope which has been allocated to a company-user by one or more of its primary credit-extending institutions for the purpose of guaranteeing foreign exchange transactions into which the user may wish to enter through means of the described system;
e) whereby the company-user derives the benefit of:
i) greater ease in conducting foreign exchange transactions,
ii) greater choice in transactional counterparties with as a consequence more competitive transaction pricing;
f) and whereby participating financial institutions derive the benefit of:
i) establishing contact with new counterparties and potential clients,
ii) accommodating the desire of existing clients for a more supple and cost-efficient foreign exchange transacting system,
iii) providing competitive foreign exchange services to their small enterprise customers where the provision of such services is not one of the institution's core competencies or where provision of such services to small businesses is not cost-effective.

2. A system for conducting foreign exchange transactions, said system comprising the steps of:
a) means for providing a host server computer or array of host server computers as necessary;
b) means for providing a user interface, database and processor with connections to banks as necessary for carrying out foreign exchange transactions;
c) means for providing a company credit information database on said host server computer or array of host server computers that contains information regarding the creditworthiness of companies adhering to the system, including the creditworthiness or credit profile of the user;
d) means for providing a database on said host server computer with information as to the credit line or envelope which has been allocated to a company-user by one or more of its primary credit-extending institutions for the purpose of guaranteeing foreign exchange transactions into which the user may wish to enter through means of the described system;
e) whereby the company-user derives the benefit of:
i) greater ease in conducting foreign exchange transactions,
ii) greater choice in transactional counterparties with as a consequence more competitive transaction pricing;
f) and whereby participating financial institutions derive the benefit of:
i) establishing contact with new counterparties and potential clients,
ii) accommodating the desire of existing clients for a more supple and cost-efficient foreign exchange transacting system,
iii) providing competitive foreign exchange services to their small enterprise customers where the provision of such services is not one of the institution's core competencies or where provision of such services to small businesses is not cost-effective.
